(19) United States
(12) Patent Application Publication
(10) Pub. No.: US 2016/0063773 A1
(43) Pub. Date: Mar. 3, 2016

(54) Apparatus and System for Generating Emergency Vehicle Record Data

(71) Applicant: Ford Global Technologies, LLC, Dearborn, MI (US)

(72) Inventors: David Anthony Hatton, Berkley, MI (US); Hussein F. Nasrallah, Dearborn Heights, MI (US); Abraham G. Philip, Rochester Hills, MI (US); Clara Bennie, Sterling Heights, MI (US)

(21) Appl. No.: 14/471,419

(22) Filed: Aug. 28, 2014

(51) Int. Cl. G07C 5/00; B60Q 9/00; B60K 35/00; G07C 5/08

(52) U.S. Cl. CPC G07C 5/008; G07C 5/0841; B60Q 9/00; B60K 35/00

(57) ABSTRACT

A first illustrative embodiment includes a restraint control module includes a transceiver in communication with a vehicle computer system, wherein the vehicle computer system is configured to communicate with a mobile device. The restraint control module also includes a processor in communication with the transceiver. The processor is configured to record an event data record, receive vehicle information from one or more vehicle sensors, determine an emergency vehicle event based upon the vehicle information and a pre-defined threshold, send the event data record to the mobile device via the vehicle computer system when an emergency vehicle event has occurred, and instruct the mobile device to send the event data record to an emergency-service provider.

### TECHNICAL FIELD

The illustrative embodiments generally relate to utilizing event data record information with a vehicle computer system.

### BACKGROUND

U.S. Pat. No. 7,953,425 discloses a universal event/data recorder system that provides a common bridge between various event/data recorders found on mobile assets. The universal event/data recorder system includes an onboard segment that is capable of interfacing with any manufacturer's event/data recorder device. Additionally, the universal event/data recorder system also includes a remote segment for accessing, analyzing and reviewing data collected from any of a plurality of event/data recorders. The universal event/data recorder system may allow accessing data from various event/data recorders using any of a number of communication means including the Internet and a wireless communication network

U.S. Pat. No. 8,612,170 discloses methods and apparatus for using black box data to analyze vehicular accidents. The methods include obtaining information from an event data recorder associated with a vehicle and using the data obtained therefrom in determining and analyzing the vehicular accident. Attributes to be analyzed include impact severity, change in velocity, and other desired parameters. Further disclosed are methods to securely communicate the downloaded black box information to a secure location for later analysis and processing.

United States Patent Publication No. 2009/0051510 discloses a system and method for monitoring a vehicle comprising an accelerometer unit capable of monitoring vehicle accelerations, a processor adapted to receive inputs from the accelerometer unit and to compare the vehicle accelerations to predetermined parameters, wherein an attack on the vehicle is identified when one or more vehicle accelerations exceed an attack threshold, and one or more transmitter units adapted to continuously transmit messages upon occurrence of an attack, wherein the messages comprise a vehicle location.

### SUMMARY

A first illustrative embodiment includes a restraint control module includes a transceiver in communication with a vehicle computer system, wherein the vehicle computer system is configured to communicate with a mobile device. The restraint control module also includes a processor in communication with the transceiver. The processor is configured to record an event data record, receive vehicle information from one or more vehicle sensors, determine an emergency vehicle event based upon the vehicle information and a pre-defined threshold, send the event data record to the mobile device via the vehicle computer system when an emergency vehicle event has occurred, and instruct the mobile device to send the event data record to an emergency-service provider.

A second illustrative embodiment vehicle computer system includes a wireless transceiver configured to communicate with a mobile device and a processor configured to determine when an emergency event has occurred. The processor is also configured to receive an event data record from a restraint control module that includes information related to the emergency event, send the event data record to the mobile device, and instruct the mobile device to contact and send the event data record to an emergency service provider.

A third illustrative embodiment includes a computer-implemented method that includes collecting and recording an encoded event data record, determining an emergency vehicle event has occurred based upon vehicle information received from a vehicle sensor, sending the encoded event data record and a data identifier decoder utilized to decode the encoded event data record to a mobile device via a wireless transceiver, and instructing the mobile device to dial an emergency operator and send both the encoded event data record and data identifier decoder.

### BRIEF DESCRIPTION OF THE DRAWINGS

FIG. 1 illustrates an example block topology for a vehicle based computing system (VCS) for a vehicle.

FIG. 2 illustrates an example of a vehicle interacting with other services and servers to communicate EDR information.

FIG. 3 illustrates the overall architecture of a restraint control module creating an EDR report.

FIG. 4 illustrates an example flow chart of a restraint control module monitoring the vehicle environment and acting upon an impact event.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

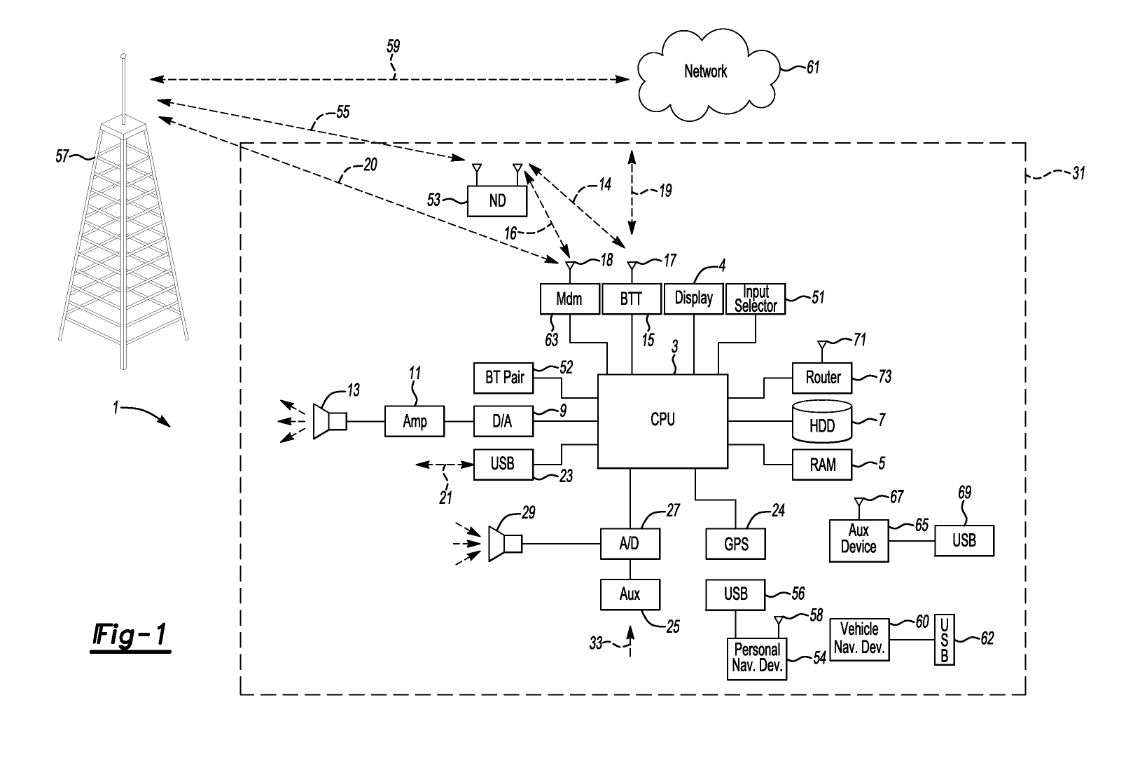

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point, DSCRC (IEEE 802.11p for lower layers and IEEE 1609 for the upper layers). SAE J2735 may be used as the Dedicated Short Range Communications (DSRC) Message Set Dictionary.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 ac network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

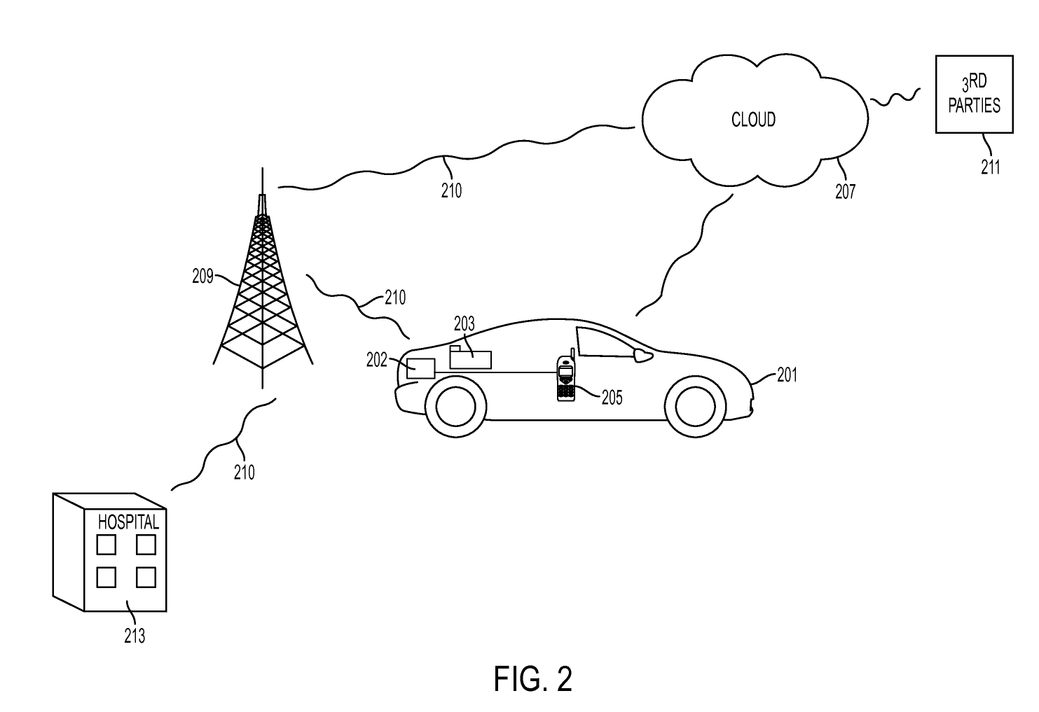

FIG. 2 illustrates an example of a vehicle 201 interacting with other services and servers to communicate event data recorder information. The even data recorder 202 may be described as a “black box” system. The event data recorders may be capable of logging a variety of system parameters used for an incident investigation, crew performance evaluation, fuel efficiency analysis, maintenance planning, and predictive diagnostics. The recorded data may include information about parameters such as vehicle speed, safety bag information (e.g. front airbag, side airbag, driver airbag, passenger airbag, etc.), seat-belt information, fuel level, engine revolution per minute, tire pressure, ambient conditions, operator controls, fluid levels, distance traveled, frontal air bag warning lamps, frontal air bag suppression switch status for either passenger, deployment time of an airbag, time to deploy the airbag for each passenger/occupant, time to various stages of airbag deployment for various occupants, time to airbag stage disposal for various occupants, pretension deployment for both driver and passenger, seat track position switch for driver and passenger, occupant size classification for driver and passenger, occupant position classification for both drivers and passengers, number of events (e.g. mutli-crash or mult-event), time between events and other similar information. Additionally, video and audio data recording may be possible.

The event data recorder may be located in a variety of vehicle modules. In one example, the EDR may be located in the restraint control module. In another embodiment the EDR may be located in the vehicle computer system, another vehicle module, or nomadic device. The event data recorder may communicate with various sensors to receive various data, including the tire pressure monitor sensors, engine control module, brake control module, GPS module, vehicle computer system, etc.

The event data recorder 202 may communicate to the internet and various servers via various connection methods. The event data recorder 202 may send vehicle information, EDR data and information, an EDR DID decoder, or other data. In one embodiment, the EDR recorder 202 may communicate with an embedded vehicle modem 203. The embedded vehicle modem 203 may communicate to the internet or cloud utilizing cellular service via cellular antennas 209. In another embodiment, the EDR recorder 202 may also include its own embedded modem to communicate with other servers. In yet another embodiment, the EDR recorder 202 may communicate with a mobile device 205. The EDR recorder 202 may communicate with the mobile device 205 directly or indirectly via another vehicle module (e.g. vehicle computer system). In other embodiments, the event data recorder 202 may also communicate to other servers, provides, and the cloud via a WiFi connection, either through an embedded WiFi modem or via another vehicle module (e.g. vehicle computer system).

When the vehicle 201 with an EDR recorder 202 communicates to off board servers, it may utilize cellular antenna 209 to communicate various cellular signals 210 back to the vehicle 201, emergency service providers 213 (e.g. hospital, doctor office, first responder, emergency operator, etc), or to the cloud 207. The EDR data may be useful to send to various emergency service providers 213 to provide accident information. The accident information can help determine what type of care could be needed for the occupants of the vehicle that experienced an emergency event.

Additionally, in another embodiment, EDR data or information may be sent to the cloud 207. The cloud may store EDR data for later distribution. For example, the cloud 207 may be utilized to distribute the EDR data to 3^{rd} parties 211. These 3^{rd} parties may include the emergency service providers listed above, as well as insurance agencies, manufacturers of the vehicle or event data recorder.

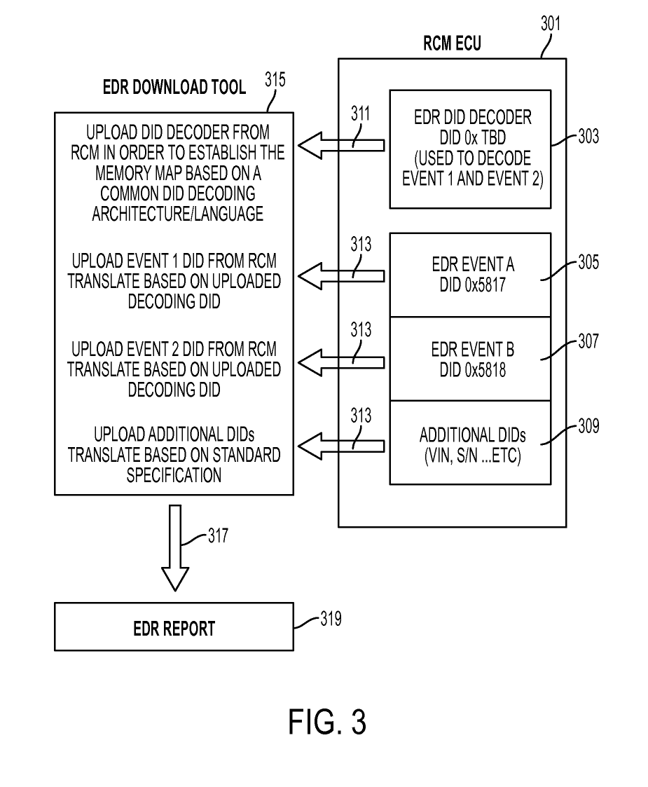

FIG. 3 is an example of the overall architecture and concept of the RCM ECU communicating with an EDR download tool to output an EDR report. As shown in FIG. 3, a restraint control module (RCM) ECU 301 may interact with an EDR download tool 315. The RCM 301 may include an event data record (EDR) Data Identifier (DID) Decoder 303 that is utilized to decode an event. The amount of bits utilized by the EDR DID Decoder may vary. The EDR DID Decoder may be sent to the EDR download tool 315 when information is uploaded. The EDR DID Decoder can then be utilized by various applications or hardware to diagnose any of the various EDR Events.

An EDR DID decoder may be utilized to assist certain embodiments of the invention. The DID decoder may assist in standardizing the event data retrieval translation aspect of the tool across different vehicle platforms. The EDR data may be presented in a format that may be difficult to decipher without a DID decoder, as only various bits and bytes may be presented without a standardized format. Thus, the decoder can help facilitate reading the EDR data. The DID decoder, along with vehicle information or EDR data, may be communicated to other parties during an emergency event.

A decoder DID may be able to handle variations between vehicle platforms and suppliers. For example, a FORD vehicle may record event data in a different format than a LINCOLN vehicle. A decoder DID may be used for various events data (e.g. event1 and event2 EDR DID) and can be available when a new decoder DID is available. Thus, the decoder may be available early in the development cycle when quality issues can be identified and resolved.

The EDR DID DECODER memory map may include a fixed area. The fixed area may include an area that includes the “supplier ID” that identifies the RCM supplier. The supplier ID may be 1 byte encoded in ASCII. In an example, 0X41 may represent the supplier AUTOLIV and 0X42 may represent the supplier BOSCH. Of course, other suppliers and manufacturers may be utilized through other values.

Another area in the memory map may identify the RCM family. The RCM family may be identified by 5 bytes encoded in ASCII. For example, the AUTOLIV RC6X family of modules may include: Byte 5—0X52, Byte 4—0X43, B3 0X36, B2—0X58, B1 0X20.

Another memory area may identify the DID decoder version. This area of memory may be an unsigned 1 byte. For example, the DID decoder version may be recognize 0X01 for version 1 and 0X0A for version 10, etc.

In another area, the EDR specification version may be identified in the RCM. It may be an unsigned 9 bytes that uses an ASCII table. In one example, a version such as RESS7.0 may be identified as shown in Table 1:

TABLE 1

| | B9 | B8 | B7 | B6 | B5 | B4 | B3 | B2 | B1 |
|---|---|---|---|---|---|---|---|---|---|
| RESS7.0 | 0X52 | 0X45 | 0X53 | 0X53 | 0X37 | 0X2E | 0X30 | 0X20 | 0X20 |

The EDR DID Decoder may include certain elements to decode and translate a EDR decoding DID. For example, an element ID may be utilized as a tool for identification of what was recorded from the EDR tables in the restraints electrical sub system (RESS). Each element that is recorded may be preassigned an element ID. Each element may have either signed or unsigned memory (e.g. 2 bytes) allocated for its identification. For example, 2 bytes may allow for 65,536 different elements to be evaluated. Requirements and regulations may change for recording a vehicle event, thus flexibility may be necessary to record additional elements. Thus, additional room for growth in the number of elements recorded is favorable. Additionally, various suppliers may request and record additional elements. As shown in Table 2, below is an example of table identifying the data elements:

TABLE 2

| Data Element Name | Element ID Decimal | Element ID Hex |
|---|---|---|
| Delta-V, longitudinal | 0000 | 0X0000 |
| Maximum delta-V, longitudinal | 0001 | 0X0001 |
| Time, maximum delta-V | 0002 | 0X0002 |
| Element N | N | Dec2Hex(N) |

The EDR DID decoder may also include a data element address. The data element address may include various parameter points to the address of the first byte for the element in the EDR DID. In one example, the EDR DID recording may include 4095 bytes. There may be room for additional growth in the EDR DID if bytes are unused.

In another embodiment, the EDR DID decoder may also include a data element length. The data element length may indicate the size (e.g. the number of bytes) for each data point in the element. It may be an unsigned byte. In one example, it may be 1 byte in length and include a maximum of 255 bytes.

In another embodiment, the EDR DID decoder may include a data element number of data points. The data element number of data points may indicate the number of data points that are recorded for the element. It may be an unsigned byte. Additionally, it may be 2 bytes in length.

In another embodiment, the EDR DID decoder may include an element that indicates where an event starts relative to the first data point, as defined by the data element address. The parameter may be 2 bytes that are unsigned. In one example, the elements that are recorded at −5 to 0 seconds at 2 Hz may have a value of 11 (0X0B). In another example, the elements that are recorded at 0 to n seconds may have a value of 0 (0X00). In yet another example, the elements such as rollover angle from −1 to 5 seconds at 10 Hz may have the value of 11 (0X0B).

The EDIR DID decoder may also include the number of bytes to skip (e.g. data is interleaved.) This parameter may be applicable for elements that have a number of multiple data points (e.g. more than one) and are not stored consecutively. A constant number of byte(s) may separate each of the data points. Thus, the number of bytes that are skipped in order to get to the next data point may be indicated. The element may be an unsigned 1 byte. The data may be stored in consecutive bytes that will have this parameter set to 0.

The EDIR DID decoder may also include indicate whether the data element is signed or unsigned, big endian or little endian, state encoded, Boolean or bit mapped. It may be an unsigned 1 byte. Each bit may be utilized for a different parameter. For example, Bit 4 may indicate whether the data element is bit mapped (e.g. 1=Yes, 0=No). Bit 3 may indicate whether the data element is Boolean (e.g. 1=Yes, 0=No). Bit 2 may indicate whether the data element is state encoded (e.g. 1=Yes, 0=No). Bit 1 may indicate the data storage method (e.g. 1=Little Endian, 0=Big Endian). Bit 0 may indicate the data type (e.g. 1=signed, 0=unsigned).

The EDIR DID decoder may also include a data element scale. This parameter may provide the data element scale using floating point single precision 32 bit (with rounding to the nearest value-mode) IEEE 754 Conversion technique. It may be a signed 4 bytes.

The EDIR DID decoder may also include an element data sample rate per second. It may be an unsigned state encoded 1 byte. If the parameter is N/A or a single event, it may be identified by $00. If the parameter is 1 sample per second, it may be $01. If the parameter is 2 samples per second, it may be $02. If the parameter is 5 samples per second, it may be $03. If the parameter is 10 samples per second, it may be $04. If the parameter is 25 samples per second, it may be $05. If the parameter is 50 samples per second, it may be $06. If the parameter is 100 samples per second, it may be $07. If the parameter is 200 samples per second, it may be $08. If the parameter is 400 samples per second, it may be $09. If the parameter is 500 samples per second, it may be $0A. If the parameter is 1000 samples per second, it may be $0B. If the parameter is 2000 samples per second, it may be $0C. Other sample rates may be encoded and defined as needed.

The RCM may record data for multiple events. For example, a vehicle may experience a vehicle accident that creates two EDR Events, Event A 305 and Event B, 307. More events may also take place. The EDR DID Decoder 303 may be sent with the Event A or Event B 307 to help decipher what each value in the memory map means for the EDR event. Additionally, additional DIDs 309 may be sent that is used by the RCM. For example, additional DIDs 309 may include the vehicle VIN, RCM serial number, or other information as explained above.

EDR event data and DIDs may be sent to the EDR download tool 315. The EDR may sent via a wired or wireless signal 313. The EDR DID decoder may be sent as well to the EDR download tool 315. It may be sent via a wired or wireless signal 311. The EDR download tool 315 may upload the DID decoder from the RCM in order to establish the memory map based on a common DID decoding architecture or language. The upload event 1 did from the RCM may be translated based on the uploaded decoding DID. Additionally, the upload event 2 DID from the RCM may translate based on the uploaded decoding DID. The upload additional DIDs translate based on standard specification.

The EDR download tool may then convert and send 317 an EDR report 319 to various devices, servers, or providers. The EDR report 319, may be sent to a mobile device or vehicle computing system to detail the vehicle event. The EDR report 319 may translate or decode the memory map of the RCM to describe a vehicle event to a person, rather than simply include bits and bytes that may not mean anything to an outside party. In another example, the EDR report 319 may be sent to a server or to the “cloud” for distribution. The “cloud” may include driver or occupant information and know where to send the relevant data. For example, the EDR report 319, may be sent to a hospital or doctor to help facilitate in recovery of a patient. The report may describe the impact and the vehicle event in detail to allow the doctor to provide appropriate medical treatment. Additionally, the cloud may be able to identify what hospital or doctor is appropriate for the patient based on the EDR report.

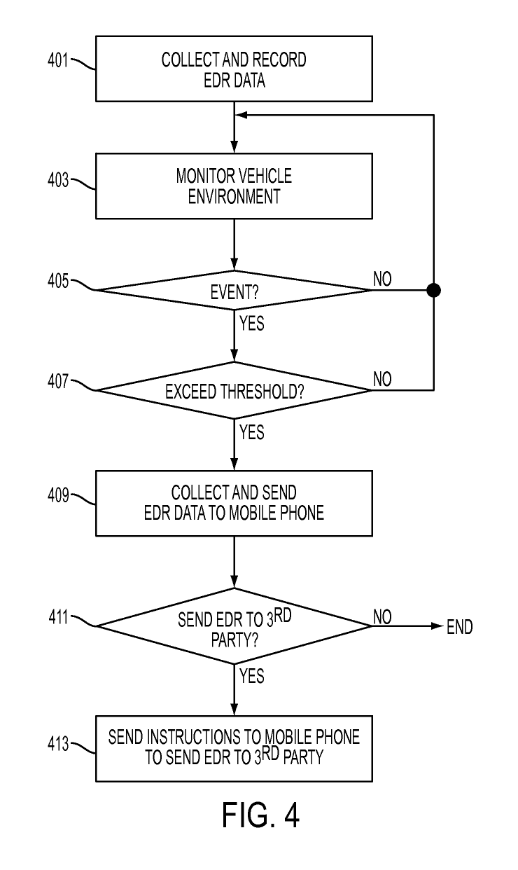

FIG. 4 is an example flow chart of a vehicle collecting, recording, and sending EDR data 401. The restraint control module (RCM) may collect and record EDR data in a passive or in an active fashion. Various EDR data that may be included any of the data elements required for vehicles equipped with an EDR. These may include the maxium delta-V (longitudinal), time (maximum delta-V), vehicle speed, engine throttle or accelerator pedal data, service brake (on/off), ignition cycle during a crash, ignition cycle during download, safety belt status, frontal air bag warning lamp, front air bag deployment (time to deploy), number of events, time from even 1 to even 2, and information whether the complete file is recorded.

The RCM may monitor for the vehicle environment 403 utilizing a variety of vehicle sensors. Vehicle sensors may include the vehicle speed sensor, accelerometer, air bag modules, safety belt modules, or other safety modules that have the ability to determine when an event takes place. The RCM may monitor both vehicle information and occupant information. information may include latitude, longitude, direction, last velocity, etc from GPS receiver/processor, street location if the vehicle is equipped with map data, vehicle type/color, vehicle emergency condition (e.g., impact, fire, rollover, fire, gasoline leak, etc.), number of occupants, seat belt status, airbag deployment, fuel cutoff status, etc. Occupant information may include name, age, address, blood type, medical allergies, medical condition, insurance information, physician information, emergency contact(s), etc. Emergency information may be stored in a plurality of storage locations including memory, storage, removable memory, or storage associated with a mobile device.

A plurality of emergency condition sensors may be interfaced as well. Such sensors may include but are not limited to air bag deployment sensors, vehicle impact sensors, dash impact sensors, seat/occupant impact sensors, rollover sensors, flame/heat sensors, gasoline sensors and an occupant-activated panic button. These sensors may operate within individual processing modules, each having a separate interface to the vehicle network for sending signals indicating a plurality of different emergency conditions.

Another subsystem that may be in communication with a vehicle computer system includes a voice synthesizer or decoder for converting digital information received from the data processor into audible speech signals, i.e. analog sound signals. The analog sound signals may be communicated through speaker, or processed at transceiver, for communication to cellular telephone transceiver across a piconet. A dual-tone multi-frequency (DTMF) interface may be provided for receiving analog DTMF frequencies and processing them as command signals to data processor, as is well known in the art of automated telephone menu systems.

Occupant identification may also be determined by the owner of the mobile device paired with the vehicle computer system, voice input at the microphone, user input at a vehicle console display, or other means including a key identifier, memory key identifier, etc.

The variety of sensors may provide data to determine when an event has occurred 405. The RCM itself may calculate an event occurring, or in another embodiment, the RCM may receive a message from another vehicle module that instructs the RCM that an event has occurred. However, not all vehicle events may trigger an embodiment of the invention.

When an event takes place, the vehicle may determine whether the event has exceeded threshold criteria 407 to trigger various actions to occur with the EDR data. If the event has not exceeded threshold criteria, the vehicle may simply continue to monitor the vehicle conditions and ignore the event. For example, a low impact accident may not trigger EDR data being downloaded in some embodiments, but a low impact accident may trigger EDR data in other embodiments. In another example, a high impact crash may trigger the event to trigger various functions to occur. For example, sending the EDR data to emergency service providers (e.g. hospitals, operators, doctors, insurance agency, emergency contacts, etc.) The threshold may be determined by an algorithm used by the RCM or another vehicle module (e.g. VCS). Additionally, another module may notify the RCM that an emergency vehicle vent as occurred.

An occupant may be notified if the RCM determines that an emergency has occurred. Occupant notification may be made warning the occupant(s) that an emergency call is going to be made, and providing the occupant(s) with an opportunity to cancel the an emergency calls.

When a threshold is exceeded (for example—a high impact accident), the vehicle may collect and send the EDR data to a mobile phone 409. The EDR data may be sent from the RCM to a vehicle computer system (VCS). The VCS may be in communication with a mobile phone in a number of ways, including via Bluetooth communication, USB communication, and other forms of data communication. The EDR data may also be sent to the mobile phone as an intermediary in order to send the data to third-party. For example, the mobile phone may send the data to a cloud-based server (e.g. off-board server). The cloud server may then be able to send the EDR data to a variety of emergency service providers.

The RCM or vehicle computer system may determine whether to send the EDR data to a third party 411. In one example, the third-party may include an ambulance, emergency operation, police station, hospital, insurance provider, emergency contact (e.g. family member or local doctor), etc. Along with the EDR data being sent, other data may be sent, including vehicle information, occupant information, and a DID decoder. The DID decoder can facilitate in translating the EDR data, as the EDR data may include only bits and bytes and may not be legible to a person.

The EDR data may be sent to certain third parties based on the type of event that occurred. A threshold value may be set for each individual third party. For example, if the RCM calculates that the event exceeds a threshold amount for an emergency operator, it may request that the EDR data be sent to the emergency operator. In another example, the EDR data may be sent to both an ambulance and emergency operator, but not an emergency contact. A user may also determine whom EDR data may be sent to during an emergency event by adjusting a vehicle setting.

The vehicle may then determine that instructions must be sent to the mobile phone to send the EDR data to a third party 413. Additionally, instructions may be sent to the mobile phone to dial a third party, such as an emergency operator, emergency contact, etc. The vehicle computer system may determine whether or not the EDR data was successfully sent to a third party. Upon a successful transmission, an output notification may notify vehicle occupants that the EDR data was successfully transmitted. The notification may be an audible output through the vehicle speakers. Additionally, the vehicle notification may be output via a display of the vehicle computer system.

In another embodiment, a notification may notify occupants that the transmission of the data was unsuccessful. The vehicle computer system and RCM may attempt to resend the EDR data. The vehicle computer system may send a request or instructions to the RCM requesting additional EDR data. Additionally, the vehicle computer system may attempt to resend the additional EDR data. In another embodiment, the RCM may attempt to send the EDR data via it's own connection.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A restraint control module, comprising:
a transceiver in communication with a vehicle computer system, wherein the vehicle computer system is configured to communicate with a mobile device;
a processor in communication with the transceiver, the processor configured to:
1.) record an encoded event data record;
2.) receive vehicle information from one or more vehicle sensors;
3.) determine an emergency vehicle event based upon the vehicle information and a pre-defined threshold;
4.) send the encoded event data record to the mobile device via the vehicle computer system when an emergency vehicle event has occurred; and
5.) instruct the mobile device to send the encoded event data record to an emergency-service provider.

2. The restraint control module of claim 1, wherein the processor is further configured to send instructions to the mobile device to dial an emergency-service provider.

3. The restraint control module of claim 2, wherein the processor is further configured to send a data identifier decoder to the emergency-service provider via the mobile device.

4. The restraint control module of claim 1, wherein the processor is further configured to generate a vehicle emergency report utilizing a data identifier decoder and the encoded event data record, wherein the vehicle emergency report describes a vehicle event utilizing the encoded event data record.

5. The restraint control module of claim 4, wherein the vehicle emergency report is sent to the mobile device.

6. The restraint control module of claim 4, wherein the vehicle emergency report includes a controller area network signal list that is recorded.

7. The restraint control module of claim 4, wherein the vehicle emergency report is sent to emergency-service provider via the mobile device.

8. The restraint control module of claim 4, wherein the vehicle emergency report is sent to an off-board server via the mobile device.

9. The restraint control module of claim 1, wherein the processor is further configured to send instructions to the vehicle computer system to output a notification to vehicle occupants that the event data record was sent to the emergency operator.

10. The restraint control module of claim 9, wherein the notification is output on a display of the vehicle computer system.

11. The restraint control module of claim 9, wherein the notification is output through one or more speakers of the vehicle computer system.

12. The restraint control module of claim 1, wherein the processor is further configured to send instructions to the vehicle computer system to output a notification to vehicle occupants that the encoded event data record was unable to be sent to the emergency-service provider.

13. The vehicle computer system of claim 1, wherein the event data record includes vehicle speed information, seatbelt information, occupant information, tire pressure monitor data, and fuel data.

14. A vehicle computer system comprising:
a wireless transceiver configured to communicate with a mobile device;
a processor configured to:
1.) determine an emergency event has occurred;
2.) receive an encoded event data record from a restraint control module that includes information related to the emergency event;
3.) send the encoded data record to the mobile device; and
4.) instruct the mobile device to contact and send the encoded event data record to an emergency service provider.

15. The vehicle computer system of claim 14, wherein the processor is further configured to translate the encoded event data record to a vehicle emergency report utilizing a data identifier decoder.

16. The vehicle computer system of claim 15, wherein the vehicle computer system outputs the vehicle emergency report on a display of the vehicle computer system.

17. The vehicle computer system of claim 15, wherein the vehicle computer system sends the vehicle emergency report to an off-board server.

18. The vehicle computer system of claim 17, wherein the vehicle computer system sends the vehicle emergency report to the emergency service provider via the off-board server.

19. The vehicle computer system of claim 14, wherein the processor is further configured to output a notification to vehicle occupants that the encoded event data record was unable to be sent to the emergency service provider.

20. A computer-implemented method implemented on a vehicle processor, comprising:
recording an encoded event record utilizing the vehicle processor;
determining an emergency has occurred based upon vehicle information received from a vehicle sensor;
sending the encoded event record and a data identifier decoder utilized to decode the record to a mobile device via a wireless transceiver; and
instructing the mobile device to dial an operator and send the encoded event record and data identifier decoder.
